(19) United States
(12) Patent Application Publication
(10) Pub. No.: US 2016/0321749 A1
(43) Pub. Date: Nov. 3, 2016

(54) Order Management and Control

(71) Applicant: TRADING TECHNOLOGIES INTERNATIONAL INC., CHICAGO, IL (US)

(72) Inventors: William D. CAMPBELL, St. Joseph, IL (US); Scott F. SINGER, Green Oaks, IL (US)

(21) Appl. No.: 14/701,033

(22) Filed: Apr. 30, 2015

(51) Int. Cl. G06Q 40/04

(52) U.S. Cl. CPC G06Q 40/04

(57) ABSTRACT

Methods and apparatus to manage hedge orders are disclosed. An example disclosed method includes communicating a multi-legged trading strategy to an electronic exchange for execution, the multi-legged trading strategy including a target trading strategy price, a quoting leg having a target leg price, a first hedge leg, and a second hedge leg. The example method further includes, in response to the quoting leg being filled at a first price that is better than the target leg price by a threshold amount: calculating a first cross-market price for the first hedge leg and a second cross-market price for the second hedge leg, calculating an actual trading strategy price as a function of the first price and the first and second cross-market prices, and, if the calculated actual trading strategy price is equal to or better than the target trading strategy price, communicating a trade action update to the electronic exchange.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

In addition to trading single items, a user may trade more than one item according to a trading strategy. One common trading strategy is a spread and trading according to a trading strategy may also be referred to as spread trading, which may attempt to capitalize on changes or movements in the relationships between the items in the trading strategy. Capitalizing on changes in the relationships between the items of the trading strategy can include adjusting trading activity of an item in view of an advantageous filling of another item in the trading strategy.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 is a flowchart representative of example machine readable instructions that may be executed to implement disclosed embodiments.

FIG. 6 is a flowchart representative of example machine readable instructions that may be executed to implement disclosed embodiments.

FIG. 7 is a block diagram representative of an example hedge order management module that can implement the example machine readable instructions of FIGS. 5 and/or 6.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments related to trading strategies and, more particularly, to methods and apparatus to manage and control the communication of hedge orders.

Trading strategies include a plurality of components and/or parameters. For example, a trading strategy such as a spread includes one or more quoting legs (e.g., a leg for which an order is placed) and one or more hedge legs. In some examples, a spread can be associated with another spread (e.g., one leg of the spread may be directed to an exchange offered spread). A combination of the different components and/or parameters determines a price of the trading strategy. Thus, when a trading strategy such as a spread is defined by a user (or a machine on behalf of the user), the trading strategy has an original, or target price. In some examples, the original price of the trading strategy represents the price desired by the user at a time of configuring the aspect(s) and/or parameter(s) of the trading strategy. Achieving the desired price can be based on setting target prices or quotes for the components of the spread, including the quoting leg(s) and the hedge leg(s). In other examples, original prices for the trading strategy and/or one or more quoting leg(s) and/or the hedge leg(s) of the trading strategy are calculated by a strategy engine based on, for example, market conditions to obtain originally calculated or expected prices for the trading strategy and/or the one or more legs.

In some examples, advantageous prices relative to the target price are obtained for the quoting leg(s) and/or the hedge leg(s). For example, a quoting leg may be filled at price that is better than the expected price for the quoting leg, thereby providing the trading strategy with an edge as a result of the advantageous price. Put another way, although the quoting leg was expected to be filled at a first price (e.g., an originally calculated price), the quoting leg was actually filled at a second price that was better than the first price, thereby resulting in unexpected profit for the transaction. For example, if the quoting leg is an order to buy one or more tradeable objects at a first price, the second price is a better price than the first price if the second price is lower than the first price. If quoting leg is an order to sell one or more tradeable objects, the second price for filling the quoting leg is a better price if the second price is higher than the first price. The difference between the two prices represents an earned edge associated with the purchase or sale of the quoting leg.

In some examples, the better-than-expected fill is a result of a change in market condition. For example, the quoting leg may have been in the market for a period of time and before the strategy engine could adjust the price for the quoting leg (e.g., in an effort to fill the leg), an unexpected change in market conditions occurred, thereby resulting in the fill of the quoting leg at a better-than-expected price resulting in an edge. In other examples, a price for the quoting order may have been directly adjusted by the trader to re-price the quoting leg at a better price (e.g., a less aggressive price) than the trading engine calculated for the leg. In such examples, if the quoting leg is filled at the better price selected by the trader, then the fill of the quoting leg also results in an edge.

In view of the edge obtained from filling the quoting leg at the better-than-expected price, reconsideration of the trading strategy with respect to the pricing of the hedge leg(s) may be warranted. Prior to filling the quoting leg, a price for the hedge leg may be set based on an expected price. Also, one or more predefined rules can determine pricing of the hedge leg after the quoting leg is filled. However, after the quoting leg is filled at the better-than-expected price, thereby resulting in an edge, reconsideration of the pricing of the hedge leg can increase efficiency with respect to filling the hedge leg.

As an example, when the quoting leg is filled at the better-than-expected price, the strategy engine may be configured to evaluate available options for filling the hedge leg (e.g., filling the hedge leg order). Example options can include attempting to achieve the originally calculated price for the hedge leg (e.g., working the hedge leg to obtain the originally calculated price) or allowing the hedge leg be filled by the market based on one or more rules, both of which may increase an amount of time that the hedge leg remains unfilled. Another option for filling the hedge leg can include filling the hedge leg at an available price that results in the hedge leg being filled substantially immediately after the filling of the quoting leg at the better-than-expected price. The available price can be associated with a potential immediate fill in the hedge leg (e.g., to buy a tradeable object if the hedge leg is an order to sell the tradeable object). In some examples, the available price is a worse price than the originally calculated price for the hedge leg. However, if filling the hedge leg at the available price results in a price for the trading strategy that would be equal to or better than a desired price for the trading strategy, then filling the hedge leg at the available price may be beneficial, even if the available price that the hedge leg is filled at is worse than the originally calculated price for filling the hedge leg. In such examples, providing an update to the trading activity of the hedge leg to cause the hedge leg to be filled at the available price optimally takes advantage of the edge obtained with respect to the quoting leg. The update includes pricing or re-pricing the hedge leg to a price or price level that results in the hedge leg being filled substantially immediately after the quoting leg is filled. Such a pricing update causes the hedge leg to cross-the-market, rather than waiting to obtain the originally calculated price or waiting for one or more trading rules to direct filling of the hedge leg. As a result of crossing-the-market, the trader of the hedge leg hits the bid by agreeing to fill the hedge leg at an available price offered by another trader. Thus, re-evaluating and updating the trading activity with respect to the hedge leg by directing the hedge leg to take the available price provides for efficiently filling the hedge leg rather than continuing to pursue a market price that could eventually result in the same or a worse trading strategy price. Allowing the hedge leg to cross-the-market for filling can increase a likelihood that the order will be completely or substantially completely filled.

Re-evaluating and/or readjusting the filling of the hedge leg(s) in view of one or more available prices to substantially immediately fill the hedge leg can occur automatically when an edge is obtained (e.g., filling the quoting leg at a better-than-expected price). An initial analysis including a contingent evaluation of the effect of filling the hedge leg(s) at an available price, rather than, for example, attempting to obtain the originally calculated price provides for an informed decision-making process as to whether the hedge leg(s) should cross-the-market for filling at the available price. If the resulting price for the trading strategy (e.g., the spread price) in view of the edge in combination with the prices obtained for the hedge leg(s) if the hedge leg(s) were to cross-the-market is equal to or better than a desired price for the trading strategy, then the hedge leg(s) cross the market. If the resulting price is determined to be worse than the original or desired trading strategy price despite the edge, then the hedge leg(s) do not cross the market and continue to be worked to obtain the originally calculated price for the hedge leg(s).

Pricing or re-pricing the hedge leg(s) in view of an available price can occur when a fill or a price update occurs to more effectively respond to changing market conditions. Further, after filling a hedge leg at a cross-the-market price, the price for the trading strategy can be re-evaluated to verify that the price is still equal to or better than the original or desired trading strategy price. Price adjustments for filling a plurality of hedge legs in the trading strategy can be made to help ensure the trading strategy price is at least equal to, or better, than the target trading strategy price. The flexible, responsive nature of the cross-the-market adjustments provides for a balanced approach to capturing the benefit of obtaining an edge.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

I. Brief Description of Certain Embodiments

Certain embodiments provide a method including communicating, by a computing device, a multi-legged trading strategy to an electronic exchange for execution, wherein the multi-legged trading strategy includes a target trading strategy price and at least three legs. The at least three legs include a quoting leg having a target leg price, a first hedge leg, and a second hedge leg. In response to the quoting leg being filled at a first price that is better than the target leg price by a threshold amount, the example method includes calculating, by the computing device, a first cross-market price for the first hedge leg and a second cross-market price for the second hedge leg. The example method also includes calculating, by the computing device, an actual trading strategy price as a function of the first price, the first cross-market price, and the second cross-market price. If the calculated actual trading strategy price is equal to or better than the target trading strategy price, the example method includes communicating, by the computing device, a trade action update to the electronic exchange.

Certain embodiments provide a tangible computer-readable storage medium comprising instructions that, when executed, cause a machine to at least communicate a multi-legged trading strategy to an electronic exchange for execution, wherein the multi-legged trading strategy includes a target trading strategy price and at least three legs. The at least three legs include a quoting leg having a first target leg price, a first hedge leg, and a second hedge leg. In response to the quoting leg being filled at a first price that is better than the target leg price by a threshold amount, the instructions cause the machine to calculate a first cross-market price for the first hedge leg and a second cross-market price for the second hedge leg and to calculate an actual trading strategy price as a function of the first price, the first cross-market price, and the second cross-market price. If the calculated actual trading strategy price is equal to or better than the target trading strategy price, the instructions cause the machine to communicate a trade action update to the electronic exchange.

Certain embodiments provide an apparatus including an interface to communicate a multi-legged trading strategy to an electronic exchange for execution, wherein the multi-legged trading strategy includes a target trading strategy price and at least three legs. The at least three legs including a quoting leg having a target leg price, a first hedge leg, and a second hedge leg. The apparatus includes a hedge order management module to, in response to the quoting leg being filled at a first price that is better than the target leg price by a threshold amount, calculate a first cross-market price for the first hedge leg and a second cross-market price for the second hedge leg and calculate an actual trading strategy price as a function of the first price, the first cross-market price, and the second cross-market price. If the calculated actual trading strategy price is equal to or better than the target trading strategy price, the hedge order management module is to communicate a trade action update to the electronic exchange.

II. Example Electronic Trading System

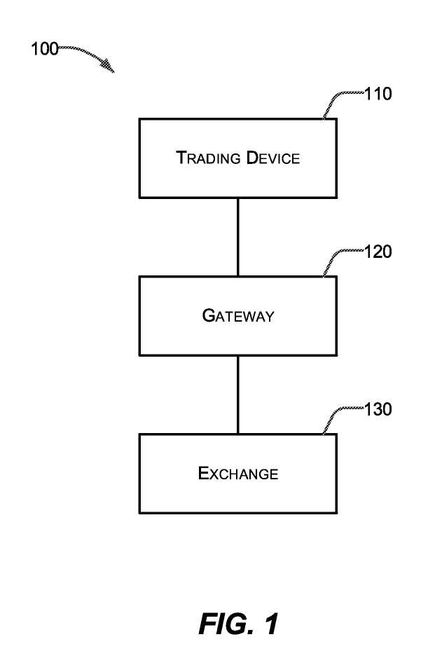

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

III. Expanded Example Electronic Trading System

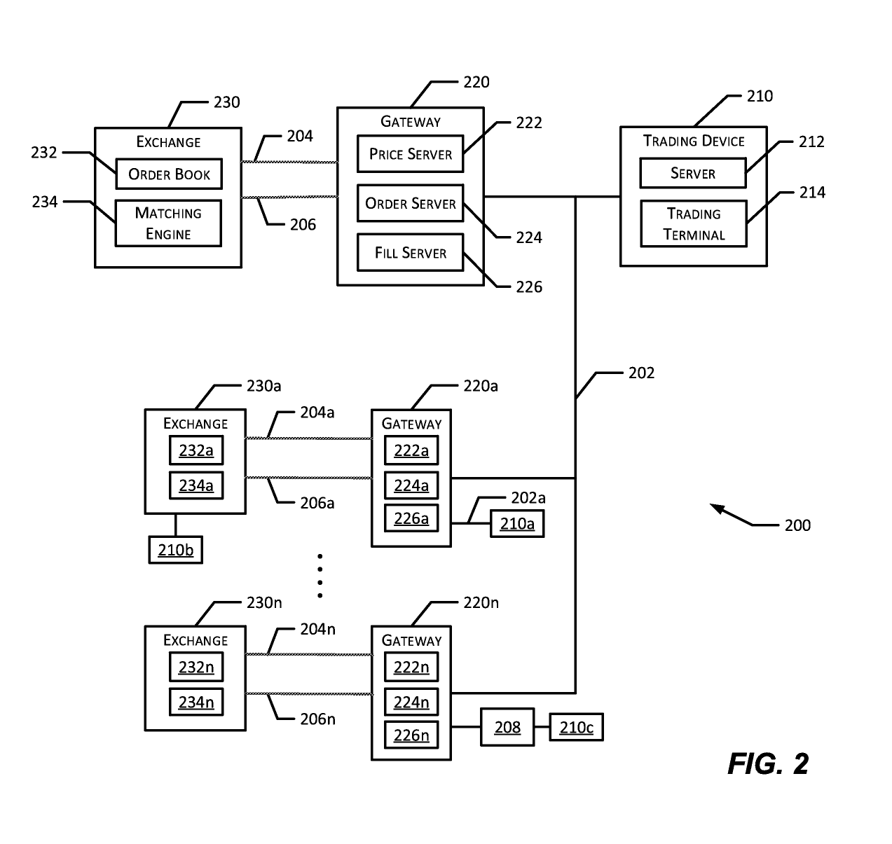

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each include instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

IV. Example Computing Device

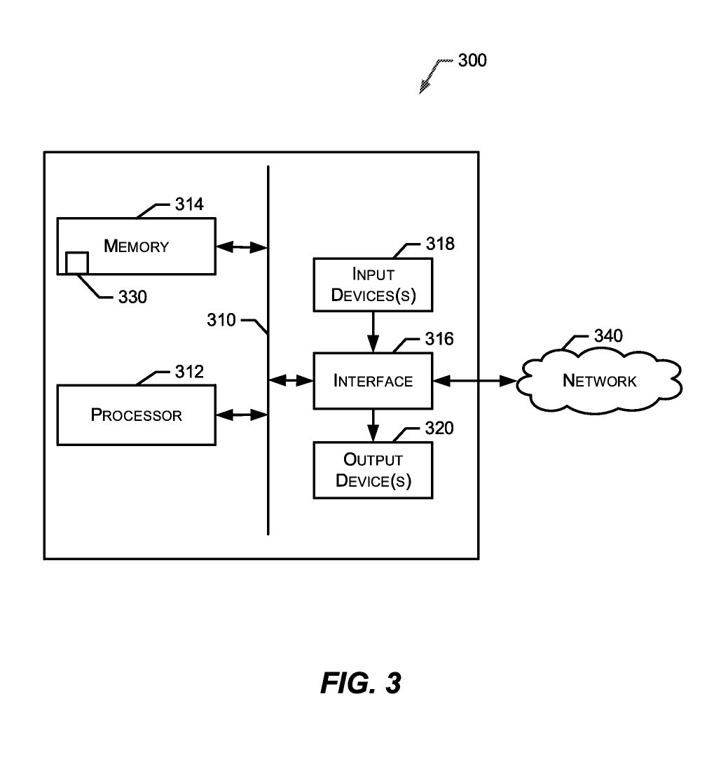

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

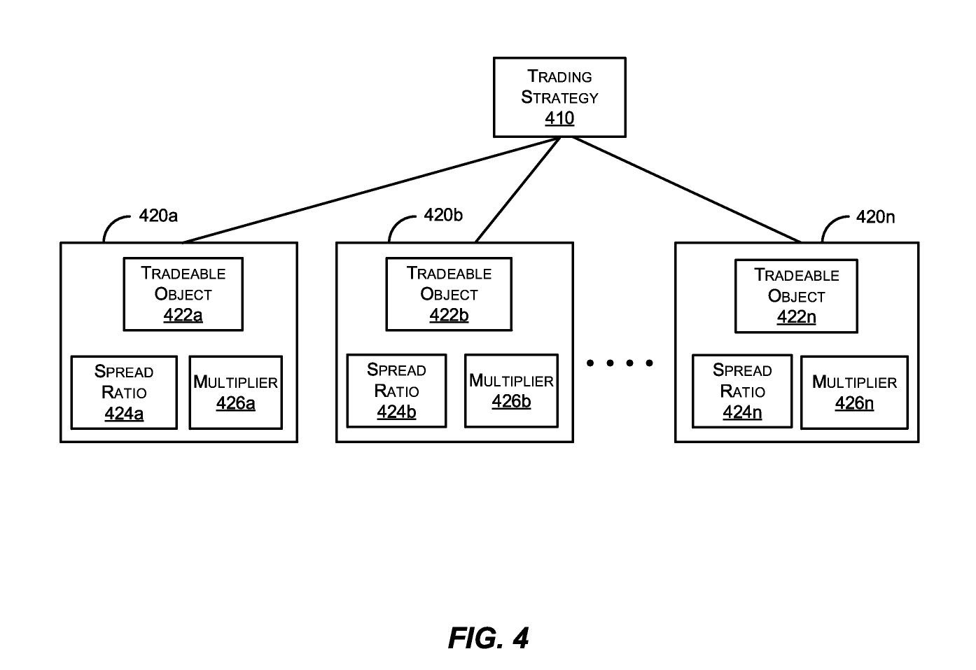

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

VI. Order Management and Control

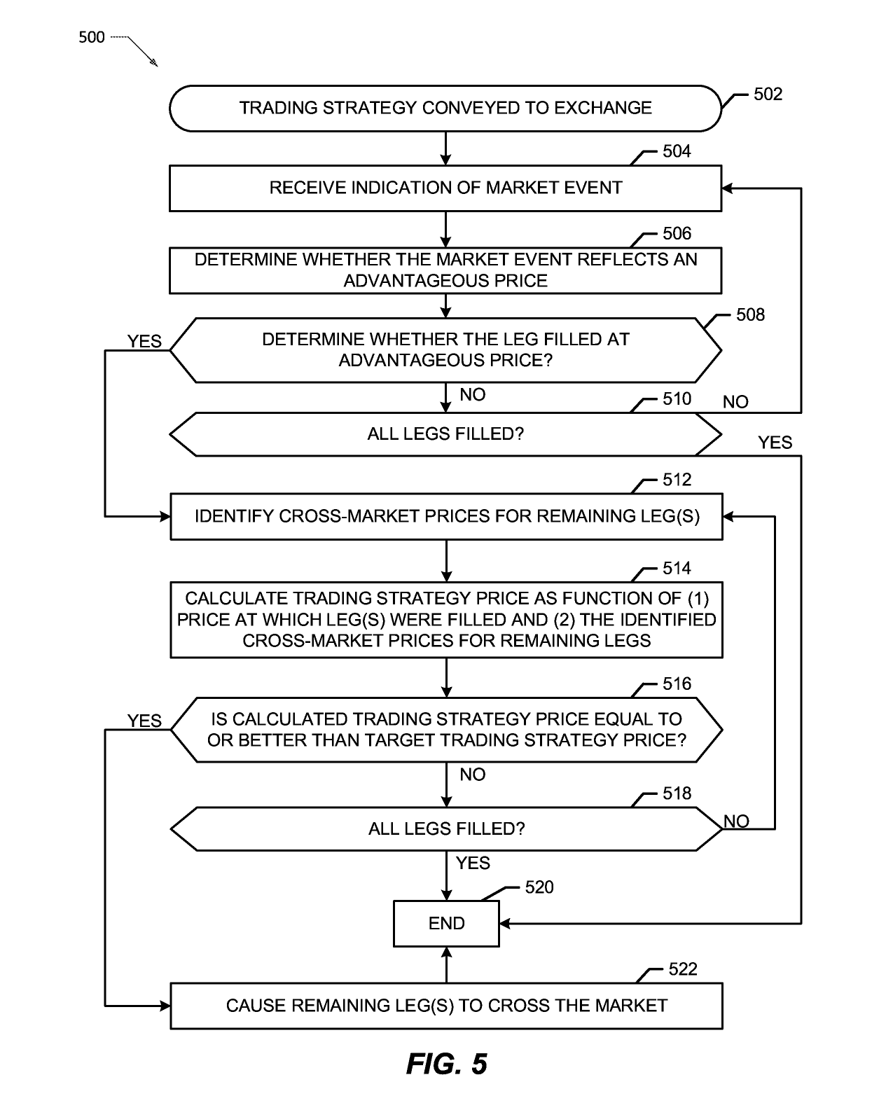

Example methods and apparatus to manage and control the communication of hedge orders when a quoting leg of a trading strategy is filled resulting in an edge are disclosed herein. As mentioned above in connection with FIG. 4, one or more objects can be traded according to a trading strategy. Individual objects or legs of the trading strategy form an interactive relationship in that filling a first leg of the trading strategy at a first price can influence a trading approach taken with respect to filling a second leg of the trading strategy. For example, a user typically has a desired or target price for completing the tragedy strategy at the time of transmitting orders defined as part of the trading strategy to the exchange. Also, a trading engine can calculate an expected price for the trading strategy and/or the one or more legs of the trading strategy. Based on market conditions, the first leg (e.g., an order for the first leg) could be filled at a better price than expected as compared to the originally calculated price. Filling the first leg at the better-than-expected price provides an edge relative to the target price for the trading strategy. Put another way, because the first leg was filled at a better price than expected, the second leg could be filled at an immediately available price that may be worse than the originally calculated price for the second leg while still meeting or, in some examples, beating the target price for the overall trading strategy (e.g., the trading strategy is completed at a better than expected price). To capitalize on the flexibility provided by the edge obtained from filling the first leg at the better price and increase efficiency in completing the trading strategy, a price for the second leg may be re-evaluated by the strategy engine to determine whether the second leg could be filled at the less favorable price immediately available price while still maintaining or improving the target trading strategy price. Re-evaluating the pricing of the second leg includes a determination of whether filling the second leg (e.g., filling an order for the second leg) at the available price results in a trading strategy price that is equal to or better than the originally requested price for the trading strategy. If the resulting trading price will be better than or equal to the original or desired price, then the second leg will be priced (or re-priced) so that the second leg crosses the market, or is filled at an adjusted price (e.g., a price substantially equal to the available price). If the resulting price of the trading strategy, in view of expected fills for one or more legs (e.g., the second leg) at a cross-the-market price, does not result in a better price for the trading strategy, then the one or more legs of the trading strategy do not cross-the-market. In such examples, the one or more legs continue to be worked at the market in an attempt to obtain the originally calculated price or a price determined by one or more trading rules. FIG. 5 is a flowchart of an example method for determining whether one or more legs of a trading strategy should cross-the-market for filling the leg(s) at price that may be different than a respective originally calculated leg price.

In the example method 500, a trading strategy is conveyed to an electronic exchange, including one or more of the exchanges 130, 230, 230a-230n of FIGS. 1 and 2 (block 502). The trading strategy includes two or more tradeable objects (e.g., the tradeable objects 422a-422n of FIG. 4), which can be referred to as legs of the trading strategy. The example trading strategy conveyed to the exchange in FIG. 5 includes one or more quoting legs, or legs for which an order is placed, as described in connection with FIG. 4. The trading strategy of FIG. 5 also includes one or more hedge legs.

The example method 500 includes receiving an indication of a market event (block 504). The market event can be, for example, a change in a price of the object for which the quoting leg order is placed relative to a market price for the object, an expected market price for the object, or a quoted price for the quoting leg. In such examples, the market event can be considered to be an opportunity for filling the quoting leg at an anomalous price. Such a market event can occur based on changes in one or more market conditions that can cause the price for the object to change relative to an originally calculated price. Further, such a market event can be temporary, in that the anomalous price is only available for a limited time before the market adjusts, equalizes, or, more generally, returns to expected conditions.

When a market event results in availability of an advantageous or better-than-expected price, one or more quoting orders may be filled at the advantageous price. For example, an advantageous or better-than-expected price is obtained if the quoting leg is a buy order and is filled at a lower price than the target or originally calculated price. If the quoting leg is a sell order, an advantageous or better-than-expected price is obtained if the price at which the quoting order is filled is higher than the target price.

The example method 500 includes a determination of whether the market event reflects an advantageous price (block 506). The example method 500 further includes a determination of whether a leg (e.g., the quoting leg) of the trading strategy was filled at the advantageous price (block 508). Whether a leg such as a quoting leg was filled at the advantageous price, thereby resulting in an edge, can be determined based on a comparison between a target price and and/or originally calculated price for the leg and a price at which the leg was filled. The edge may be used to offset the filling of other legs of the trading strategy at worse than desired prices if the overall resulting price for the trading strategy in view of the edge and the expected filling of the other legs in the trading strategy is equal to or better than the desired trading strategy price.

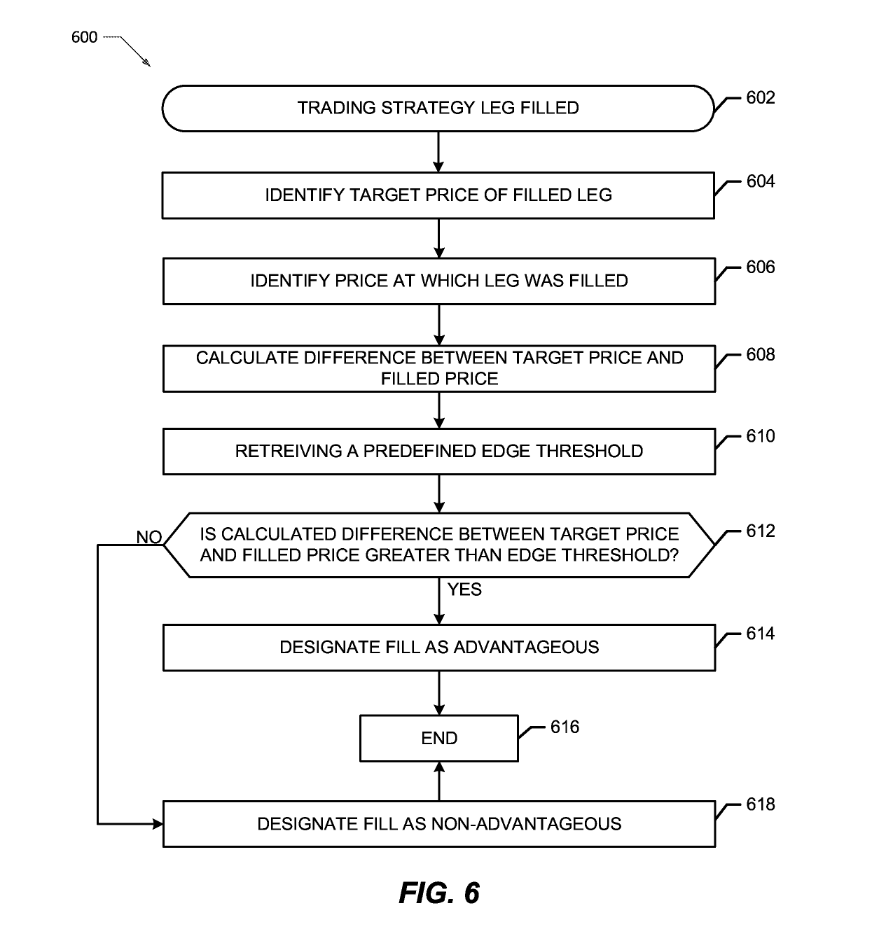

FIG. 6 is a flowchart of an example method 600 for determining whether a leg of a trading strategy was filled at an advantageous price. In some examples, the method of FIG. 6 can be implemented in connection with the example method 500 of FIG. 5 and in particular, block 508 for determining whether a leg of the trading strategy was filled at an advantageous price. The example method 600 includes filling a leg (e.g., filling an order for a leg) of a trading strategy at an exchange (block 602). The filled leg of the trading strategy can be a quoting leg and/or another leg of the trading strategy. For illustrative purposes, the filled leg of the example method 600 will be referred to as a quoting leg. In some examples, the quoting leg is filled at a market price or as result of negotiating or adjusting a price for the quoting leg based on market conditions. In other examples, the quoting leg is filled at the exchange at an anomalous price as a result of a market event, as described in connection with the example method 500 of FIG. 5 (e.g., blocks 504, 506).

When the quoting leg is conveyed to the exchange, the quoting leg has an associated target price, or price at which the quoting leg is expected to be filled (e.g., an initial or originally calculated price for which the quoting leg is to be filled). The example method 600 includes identifying the target price of the filled quoting leg (block 604). The example method 600 also includes identifying a price at which the quoting leg was filled (block 606). In some examples, the price at which the quoting leg was filled is different from the target price. For example, the quoting leg can be filled at a price that is better than the target price. As described above in connection with the example method 500 of FIG. 5, in some examples, a market event can result in the quoting leg being filled at a price that is better than the target price. In other examples, the price at which the quoting leg is filled may be worse than the target price (e.g., due to market conditions).

As part of determining whether the quoting leg was filled at an advantageous price, the example method 600 includes comparing the target price and the price at which the quoting leg was filled (block 608). In the example method 600, comparing the target price and the filled price includes calculating the difference between the target price and the fill price to determine whether, for example, a buy order was filled at lower price than expected or a sell order was filled at a higher price than expected.

Filling of the quoting leg at a price that is better than the target price results in an edge relative to the expected price for filling the quoting leg. In some examples, the filled price is substantially close to the target price, such that although the filled price was better than the target price, the difference between the target price and the filled price and, thus, the resulting edge, is relatively small. In other examples, the filled price is substantially different from the target price and thus, the acquired edge is greater. Such examples can result from the filling of the quoting order for the purchase of one or more tradeable objects at a substantially low price due to a market event.

The example method 600 includes retrieving or accessing one or more predefined edge thresholds (block 610). The edge threshold is an amount of edge (e.g., as defined by price ticks) that is required for one or more legs of the trading strategy to cross-the-market. The edge threshold can include a number of price levels or tiers and can be dynamically configured based on, for example, market conditions, algorithms, and/or data feeds. For example, the target price can be associated with a first price level (e.g., the target price falls within a first range) and the filled price associated with a second price level (e.g., the filled price falls within a second range different from the first range). In other examples, the edge threshold includes an amount of money or price levels by which the filled price differs from the target price. The edge threshold can include other standards or criteria, such as a percentage by which the filled price differs from the target price.

In some examples, the edge threshold is based on one or more target prices for filling the trading strategy. For example, the edge threshold may be representative of, or associated with, a price for the trading strategy if one or more legs of the trading strategy are filled at their respective target prices.

The example method 600 includes determining whether the difference calculated between the target price and the filled price is greater than the edge threshold (block 612). Determining whether the calculated difference is greater than the edge threshold can include comparing a value or amount of the difference between the target price and filled price and a value of the edge threshold, for example. The determination can also be based on a comparison of price levels with respect to the calculated difference and the edge threshold, for example.

If the calculated difference between the target price and the filled price is greater than the edge threshold, the fill of the quoting leg is designated as advantageous (block 614). For example, if a price at which the quoting leg was filled for buying one or more tradeable objects was less than the target price, the filling of the quoting order was generally favorable in that less money than expected was spent to fill the quoting order. Further, the amount of edge obtained as a result of the fill price was greater than the edge threshold. Thus, filling the quoting order resulted in a fill that places the quoting leg at an advantage to the target price for the quoting leg and/or the trading strategy price. Thus, the amount of edge obtained can provide for flexibility in filling the other legs of the trading strategy at, for example, worse prices, without resulting a worse-than-expected overall price for the trading strategy. For example, the amount of edge obtained from the filling of the quoting leg can be used to offset the filling of one or more legs in the trading strategy at a worse price. Thus, the fill of the quoting order is designated as advantageous for providing an opportunity for flexibility or leeway in filling one or more other legs in the trading strategy. Upon designating the fill as advantageous, example method 600 ends and returns to the example method 500 of FIG. 5 to determine whether one or more legs of a trading strategy should cross-the-market (block 616).

If the calculated difference between the target price and the filled price is less than the edge threshold, the fill is designated as non-advantageous (block 618). In some examples, the filled price is better than the target price, however, the target price and the filled price are substantially close such that the difference is negligible or substantially negligible and thus, the amount of edge obtained does not meet edge threshold. In other examples, the filled price is worse than the target price and, thus, not applicable for exceeding the edge threshold. In such examples, the example method 600 returns to the example method 500 of FIG. 5 (block 616).

Returning to the example method 500 of FIG. 5, if the leg is not filled at an advantageous price (e.g., as determined at block 612 of the example method 600 of FIG. 6), the example method 500 includes a determination of whether all legs in the trading strategy have been filled (block 510). If all legs have not been filled, the example method 500 returns to receive an indication of a market event if and/or when the market event occurs (block 504). If all the legs of the trading strategy are filled (block 510), the example method 500 ends (block 520). In such examples, the legs of the trading strategy can be filled based on one or more trading rules or price adjustments configured by the user.

If the leg has been filled at an advantageous price (e.g., as determined at block 612 of the example method 600 of FIG. 6), the example method 500 continues with identifying a cross-market price for one or more remaining legs of the trading strategy (block 512). Thus, after filling the leg at the advantageous price, rather than waiting for the other leg(s) to be filled at the respective originally calculated prices for the leg(s), the example method 500 evaluates whether the desired trading strategy price can be obtained by filling the other leg(s) at immediately available prices. Identifying cross-market prices for the remaining leg(s) includes determining whether there are one or more orders available to fill the remaining leg(s) such that the remaining leg(s) could be immediately filled to hit the bid (e.g., fill the leg(s) at the price offered by the available order(s)). Thus, a cross-market price includes a price or price level for which a given leg could be filled at the market substantially immediately after the filling of the quoting leg, such as a first available price. The cross-market price can be different than an originally calculated price for a leg, and in some examples, the cross-market price is worse the originally calculated price for the leg. The cross-market price can be, for example, a first available price for filling the leg or a price that deviates from the market price or an expected market price. The cross-market price can be identified based on an amount or a degree of the edge obtained from filling the quoting leg (e.g., the amount of edge can determine which prices are identified as available cross market prices for a hedge leg). In some examples, one or more cross-market prices are identified for a respective hedge leg (e.g., a first available price, a second available price).

The example method 500 continues with calculating a trading strategy price as a function of (1) a price at which the leg(s) (e.g., the quoting leg) were filled and (2) the cross-market prices identified for the one or more remaining legs (e.g. hedge leg(s)) of the trading strategy (block 514). As disclosed above, the cross-market prices identified for the remaining leg(s) of the trading strategy can include a potential price for the hedge leg(s), such as an originally calculated price and/or a price different from the originally calculated price, such as a first available price and/or a second available price. The example method 500 determines an effect of filling the remaining leg(s) in the trading strategy at the identified cross-market price by stimulating, modeling, estimating, and/or calculating the trading strategy price if the remaining leg(s) were to be filled at the identified cross-market price. In some examples, determining the calculated trading strategy price includes calculating one or more trading strategy prices using one or more identified cross-market prices for one or more hedge legs (e.g., the first available price, the second available price). Thus, the example method 500 accounts for the effects of different cross-market prices on the trading strategy price in view of the price at which the quoting leg was filled.

Calculating the trading strategy price as a function of the price at which the quoting leg(s) were filled and the cross-market prices identified for the remaining leg(s) can be based on one or more methods described in connection with FIG. 4, for example.

In some examples, the calculated trading strategy price is determined and/or re-calculated after two or more quoting legs are filled. In such examples, the example method 500 includes calculating the trading strategy price based on the price(s) at which the two or more quoting legs are filled and the cross-market prices identified for the remaining legs. In some examples, the cross-market prices identified for the remaining legs are adjusted as result of filling the two or more quoting legs. For example, after a first quoting leg is filled, the cross-market prices for the remaining legs are identified based on the advantageous or non-advantageous of the filling price of the first quoting leg (e.g., how much edge was obtained as result of the price at which the first quoting leg was filled). Filling a second quoting leg can increase or decrease an amount of edge associated with the trading strategy depending on, for example, the degree or amount of advantage resulting from the price at which second quoting leg was filled (e.g., if the second quoting leg was filled at a less advantageous price than the first quoting leg or a non-advantageous price, then an edge obtained from filling the first quoting leg at, for example, an advantageous price, may decrease). Thus, the calculated trading strategy price can be updated during filling of the trading strategy to account for the effect of filling two or more quoting legs at different prices.

Further, the calculated trading strategy price can be calculated after a fill of any leg in the trading strategy (e.g., a fill of one or more quoting leg and/or hedge leg orders). For example, if a plurality of hedge legs of a spread are at the market and one of the hedge legs is filled at a better-than-expected price, the spread price can be calculated to determine if the spread price attained in view of the previously obtained fills (e.g., a fill price for a quoting leg of the spread and better-than-expected fill price of the hedge leg) and the proposed fill(s) of the remaining hedge leg(s) at cross-market prices is the same or better than the desired spread price. Thus, in the example method 500, a fill of any leg in a trading strategy and/or a price update can trigger the calculation of the trading strategy price in view of the filled prices and the available cross-market prices.

In the example method 500, a determination is made whether the calculated trading strategy price is equal to, substantially equal to, or better than a target trading strategy price (block 516). The target trading strategy price can include a desired price, an original price, and/or an expected price for the trading strategy.

To determine whether the calculated trading strategy price is equal to, substantially equal to, or better than a target trading strategy price, the value of the calculated trading strategy price is compared to the value of the target trading strategy price. In making the comparison between the calculated trading strategy price and the target trading strategy price, the example method 500 evaluates whether filling the hedge leg(s) at an identified cross-market price (e.g., block 512) will result in the same or better price for the trading strategy in view of edge obtained from the advantageous filling of the quoting leg (e.g., block 506). As disclosed above, filling the quoting leg(s) at an advantageous price provides the trading strategy with an edge. The edge obtained from the advantageous price of the quoting leg can place the calculated trading strategy price at an advantage to the target trading strategy price. Put another way, when the quoting leg is filled at a better price than expected, greater flexibility results for filling the other (hedge) legs of the trading strategy at prices that deviate from the originally calculated prices for those legs without detriment to the target trading strategy price. Thus, in some examples, even if a hedge leg is filled at an identified cross-market price that is worse than the originally calculated target or desired price for the hedge leg, the calculated trading strategy price for the overall trading strategy may remain equal to the target trading strategy price or may be better than the target strategy price as a result of the edge.

If the calculated trading strategy price is worse than the target trading strategy price, than filling the remaining leg(s) at the identified cross-market price will not be beneficial to the trading strategy. For example, although a quoting leg may have been filled at an advantageous price, thereby resulting in an edge for the trading strategy, an identified cross-market price for a remaining first hedge leg for sell order may be low such that if the first hedge leg is filled at the low cross-market price, any benefit provided by the edge is negligible or irrelevant because of the low cross-market price. In such examples, the resulting calculated trading strategy price as function of the price of the quoting leg and the low cross-market price may be worse than target trading strategy price. Thus, a better trading strategy price (e.g., a price closer to the target trading strategy price) could be obtained by continuing to pursue other prices for filling the first hedge leg (e.g., prices closer in value to the originally calculated price for the first hedge leg).

If the calculated trading strategy price is worse than the target trading strategy price, the example method 500 recognizes that a better trading strategy price could be obtained by, for example, waiting to fill the first hedge leg until an order is available to fill the first hedge leg at a price substantially comparable to the expected or originally calculated price and/or a price that may be favorable in view of changing market conditions. In such examples, the example method 500 does not adjust the trading strategy and/or does not cause the first hedge leg to be filled at the identified cross-market price. In other examples, a price for the first hedge can be updated by the trader and/or re-calculated. Thus, the first hedge leg may be filled at a price other than the identified cross-market price. The example method 500 can refrain from adjusting the trading strategy or can provide an indication that the trading strategy should proceed as filed.

In examples where the calculated trading strategy price is worse than the target trading strategy price, the example method 500 continues with determining whether all legs of the trading strategy have been filled (block 518). If all the legs of the trading strategy have been filled, the example method 500 ends (block 520).

If all the legs of the trading strategy have not been filled, the example method 500 continues to identify cross-market prices for the remaining leg(s) of the trading strategy (block 512). Referring to the example above where filling the first hedge leg for the sell order at the low cross-market price did not result in a calculated trading strategy price that was equal to or better than the target trading strategy price, such an example trading strategy could include a second hedge leg that has not yet been filled. The example method 500 identifies a cross-market price for the second hedge leg (e.g., an available price for the second hedge leg). The example method 500 then calculates the trading strategy price as a function of the price at which the quoting leg was filled and the identified cross-market price for the second hedge leg (block 512).

In some examples, if the first hedge leg has been filled in an ensuing time period, the calculation of the trading strategy price can be a function of the price at which the quoting leg was filled, the price at which the first hedge leg was filled, and the identified cross-market price for the second hedge leg. For example, if the quoting leg was filled at an advantageous price, thereby resulting in an edge, and the first hedge leg was filled at a market price substantially equal to the target price for the first hedge leg or a better price for the first hedge leg (e.g., a higher price than the target price for the sell order of the first hedge leg), the edge can still provide a benefit to the trading strategy. As the first hedge leg was filled at a target or better price than expected, the edge obtained from filling the quoting leg at an advantageous price can still be available or partially available to provide flexibility with respect to filling the second hedge leg at a cross-market price. The example method considers whether the re-calculated trading strategy price (e.g., the trading strategy price calculated in view of the prices for filling the quoting leg and the first hedge leg and the identified cross-market price for the second hedge leg) is equal to or better than the target trading strategy price (block 516).

Thus, the example method 500 re-evaluates the calculated trading strategy price after events such as filling the first hedge leg. Such re-evaluation provides for a comparison of the current or substantially current calculated trading strategy price and the target trading strategy price and thus, provides substantially real-time consideration of whether the calculated trading strategy price is equal to or better than the target trading strategy price in view of market conditions.

If the calculated trading strategy price is equal, substantially equal to, to or better than the target trading strategy price, then the example method 500 includes adjusting or altering the trading strategy to cause the remaining leg(s) to cross-the-market such that the remaining leg(s) are filled at the identified cross market price(s) (block 522). As a result of the determination that the calculated trading strategy price is equal to or better than the target trading strategy price, the example method 500 recognizes that filling the remaining leg(s) (e.g., the remaining hedge leg(s)) at the identified cross-market price can increase a likelihood that the remaining leg(s) will be filled and can improve efficiency in completing the trading strategy without detriment to the target trading strategy price. Thus, rather than attempting to achieve the originally calculated price for the remaining leg(s) or re-pricing the leg(s) to attempt to achieve another price, the remaining leg(s) is filled based on the available cross-market price. In some examples, the example method 500 allows the remaining leg(s) to cross-the-market if the calculated trading strategy price is within or above a threshold or degree of the target trading strategy price (e.g., a remaining leg is permitted to cross-the-market if the calculated trading strategy price is less than the target trading strategy price by predetermined amount).

The example method 500 causes the remaining leg(s) to cross-the-market by altering one or more aspects of the run-time parameters associated with the trading strategy. Altering or adjusting the trading strategy can include communicating a trade action update to the exchange. For example, the example method 500 can adjust or update a price of the order(s) for the remaining leg(s). Changing the price can include adjusting a price at which the remaining leg(s) are to be filled relative to the identified cross-market price (e.g., to match or substantially match the identified cross-market price). Adjusting the price can include setting a new target price for the remaining leg(s). In other examples, the trade action update includes entering one or more orders for filling the remaining leg(s) at the cross-market price. Such adjustments increase a likelihood that the remaining leg(s) are filled, for example, at the identified cross-market price(s) and thereby benefit from and/or take advantage of the edge obtained from the filling of the quoting leg at the advantageous price. Other aspects of the trading strategy and/or the remaining legs(s) can be adjusted as part of crossing the market (e.g., a quantity of the remaining leg(s)).

In some examples, after one or more legs crosses the market and is filled at the identified cross-market price, the example method 500 recalculates the trading strategy price to determine whether the calculated trading strategy price remains substantially equal to or better than target trading strategy price (e.g., repeat blocks 514 and 516). Such a determination provides a checkpoint and/or an evaluation to verify that causing the remaining leg(s) to cross-the-market provided the expected or substantially expected result of filling the remaining leg(s) without negatively affecting the trading strategy price. Thus, the example method 500 continuously or substantially evaluates the calculated trading strategy price after order fills and/or price updates. Such monitoring can provide for consideration of the effect of filling the remaining leg(s) at the cross-market price(s) on the available edge, a determination of an amount of edge remaining after filling the leg(s) at the cross-market price(s), identification of new opportunities to cross-the-market for other legs in the trading strategy, detection of patterns in filling the legs at the cross-market price(s), changes in market conditions, etc.

If the calculated trading strategy price continues to be equal to, substantially equal to, or better than the target trading strategy price, the example method 500 can identify cross-market prices for other legs in the trading strategy (e.g., block 512), evaluate whether filling the other legs at the identified cross-market prices will maintain the substantially equal to or better trading strategy price (e.g., blocks 514, 516), and cause the other legs to cross-the-market (e.g., block 520) or to not cross-the-market and continue to pursue other prices for filling.

As another example of implementation of the example method 500, the remaining legs (e.g., the hedge legs) after filling of one or more quoting legs can be considered based on liquidity (e.g., a degree to which the hedge legs can be bought or sold without affecting or substantially affecting the market price or available quantity of the underlying tradable object). In such examples, the hedge legs are ordered from least-liquid to most-liquid. The calculated trading strategy price can be determined as a function of the filling price(s) for the quoting leg(s) and an identified cross-market price for an unfilled, least-liquid hedge leg relative to the other hedge legs. Such examples can include making an assumption that the remaining hedge legs will be filled and that filling the remaining hedge legs will result in calculated trading strategy price that substantially equal to or better than the target trading strategy price as result of the liquidity of the remaining hedge legs. Thus, the unfilled, least-liquid hedge leg can cross-the-market based on the assumption that filling the remaining hedge legs will not negatively affect the trading strategy price. Such examples can be implemented for considering a hedge leg individually with respect to crossing the market.

When the legs of the trading strategy are filled, whether at cross-market prices or otherwise, the example method 500 ends (block 520).

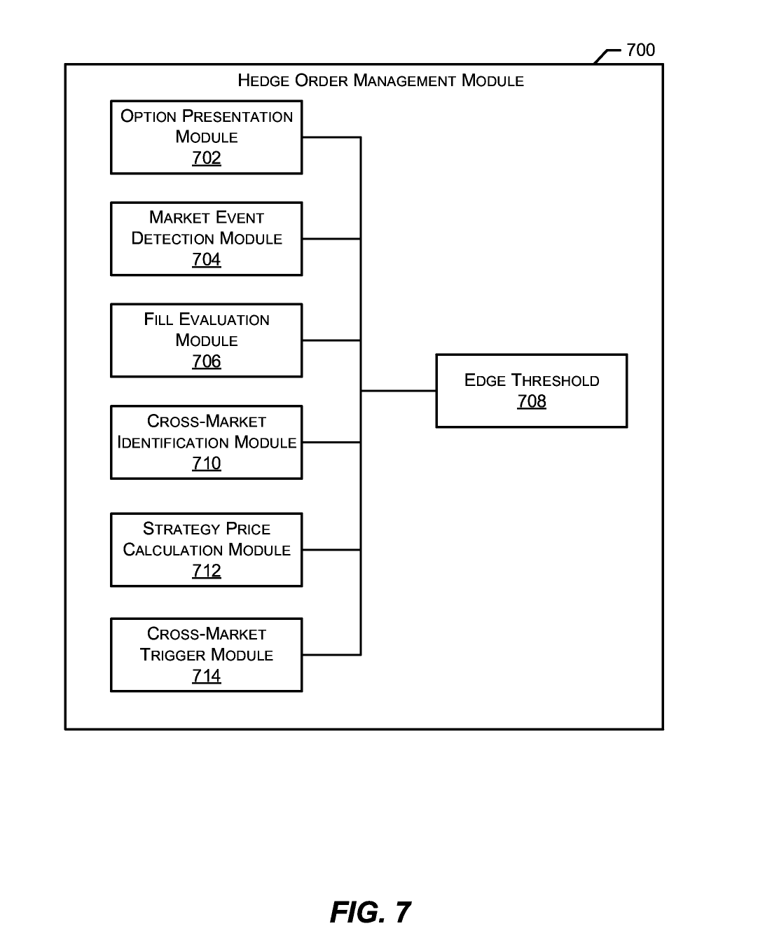

FIG. 7 is a block diagram of an example hedge order management module 700 that may implement and/or execute the example operations of FIGS. 5 and 6. In some examples, the module 700 may be implemented as part of software (or an application) associated with the trading device 110 and/or the gateway 120 of FIG. 1. In some examples, the control module 700 may be implemented as computer implemented code or instructions operable independent of software associated with the trading device 110 and/or the gateway 120. In some examples, the features and functionality of the control module 700 may be implemented in hardware operable in connection with the trading device 110 and/or the gateway 120 of FIG. 1. Also, in some examples, the control module 700 implements and/or is associated with the trading strategy 410 of FIG. 4 (e.g., spread trading).

The example module 700 of FIG. 7 includes an option presentation module 702 to convey or transmit a trading strategy to an exchange (e.g., the exchange 130 of FIG. 1) for filling at the exchange. The trading strategy conveyed by the option presentation module 702 can include one or more quoting legs and one or more hedge legs. The option presentation module 702 can transmit the trading strategy to the exchange and record or, more generally, store one or more target, expected, and/or originally calculated prices for filling the legs of the trading strategy and/or one or more target prices for the trading strategy. In some examples, the target prices for the legs and/or the trading strategy can be stored by the trading device 110 and/or the gateway 120 of FIG. 1. Also, the option presentation module 702 can communicate the trading strategy to the exchange as a result of a user selection via an interface of the trading device 110.

The example module 700 includes a market event detection module 704 to detect one or more market events at the exchange. The market event detection module 704 can identify one or more anomalous prices resulting from the detected market event(s). The market event detection module conveys an indication of the market event(s) to, for example, the trading device 110 and/or the gateway 120 of FIG. 1. Receipt of the indication of the market event(s) by the trading device 110 and/or the gateway 120 can occur substantially as disclosed in connection with FIG. 5 (e.g., block 504).

As disclosed above, the legs of the trading strategy are filled at the exchange and the prices at which the legs are filled can be the same or substantially the same as the target prices for the legs or can differ from the target prices. To assess cost(s) of filling a leg of the trading strategy, the example module 700 includes a fill evaluation module 706. The fill evaluation module identifies a target price for filling the leg and a price at which the leg was filled (e.g., as disclosed in connection with the example method 600 of FIG. 6 (blocks 604, 606)). The fill evaluation module 706 determines whether the leg was filled at an advantageous price by evaluating whether an edge was obtained from filling the leg (e.g., as disclosed in connection with the example method 500 of FIG. 5 (blocks 506, 508) and the example method 600 of FIG. 6 (blocks 608-618)).

In determining whether the leg was filled at an advantageous price, the fill evaluation module 702 calculates a difference between the target price for filling the leg and the filled price for filling the leg and compares the calculated difference to an edge threshold 708 (e.g., blocks 608-612 of the example method 600 of FIG. 6). The edge threshold 708 is a predetermined level or criteria for determining whether the fill of the leg was advantageous and provided a predefined amount of edge such that the remaining leg(s) of the trading strategy can be considered for filling at cross-market prices. The edge threshold 708 can be based on, for example, a price for filling the trading strategy and/or target prices for filling the legs of the trading strategy. The edge threshold 708 can be a price level, an amount, a percentage, etc. The edge threshold 708 can be selected by a user via the trading device 110 of FIG. 1.

If the fill evaluation module 706 determines that the leg was filled at an advantageous price in view of the edge threshold 708, a cross-market identification module 710 of the example module 700 identifies cross-market prices for the remaining leg(s) of the trading strategy (e.g., as disclosed in connection with block 512 of the example method 500 of FIG. 5). The cross-market identification module 710 identifies, for example, one or more available prices for the remaining leg(s). The cross-market identification module 710 can survey the exchange and/or exchange conditions to detect cross-market prices. In some examples, the cross-market identification module identifies a first available price, a price that deviates from a target price for the remaining leg(s) and/or a price that deviates from a market price as a cross-market price. In some examples, the cross-market identification module 710 considers an amount of edge obtained in determining whether a price can or should be identified as a potential cross-market price for the remaining leg(s).

The example method 700 includes a strategy price calculation module 712 to calculate a trading strategy price a function of (1) the price at which one or more legs (e.g., quoting legs) were filled and (2) the identified cross-market price(s) for the remaining leg(s) to be filled (e.g., as disclosed in connection with block 514 of the example method 500 of FIG. 5). The strategy price calculation module 712 determines the calculated trading strategy price using one more calculations for determining the price of a trading strategy (e.g., such as spread trading as substantially disclosed in connection with the trading strategy 410 of FIG. 4). The strategy price calculation module 712 stimulates and/or models the calculated trading strategy price as if an identified cross-market price for a remaining leg were the price at which the remaining leg was filled. In some examples, the strategy price calculation module 712 determines the calculated trading strategy price after one or more trading events or price updates (e.g., after the filling of each quoting leg and/or each hedge leg of the trading strategy).

In some examples, the strategy price calculation module 712 compares the calculated trading strategy price to the target trading strategy price to determine whether the calculated trading strategy price is equal to, substantially equal to, or better than the target trading strategy price. In other examples, the comparison is performed by a cross-market trigger module 714 of the example module 700. If, based on the comparison, the strategy price calculation module 712 and/or the cross-market trigger module 714 determine that the calculated trading strategy price is equal to, substantially equal to, or better than the target trading strategy, price, the cross-market trigger module 714 causes the remaining leg(s) to cross-the-market to be filled at the identified cross-market price(s).

The cross-market trigger module 714 generates and communicates one or more trade action updates for the remaining leg(s) to the exchange. By sending a trade action update, the cross-market trigger module adjusts and/or alters the trading activity of the trading strategy, and in particular, the trading activity of the one or more remaining legs so that the remaining legs are filled at the identified cross-market prices. The trade action update sent by the cross-market trigger module 714 can include a trigger or a directive for an order of a remaining leg to accept a cross-market price identified for that leg. The cross-market trigger module 714 automatically sends the trade action update to the exchange based on the determination that the calculated trading strategy price is the substantially the same or better in view of the identified cross-market price and the available edge. However, in other examples, the cross-market trigger module 714 can present an option to adjust the trading activity of the one or more remaining legs to a user via the trading device 110 of FIG. 1 before sending the trade action update. Also, in examples where the calculated trading strategy price is not equal to or better than the target trading strategy price, the cross-market trigger module 714 refrains from sending an trade action update or can send an indication that the remaining leg(s) should be filled or attempt to be filled at market prices and/or originally calculated target prices.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method, comprising:
communicating, by a computing device, a multi-legged trading strategy to an electronic exchange for execution, wherein the multi-legged trading strategy includes a target trading strategy price and at least three legs, the at least three legs including a quoting leg having a target leg price, a first hedge leg, and a second hedge leg;
in response to the quoting leg being filled at a first price that is better than the target leg price by a threshold amount:
calculating, by the computing device, a first cross-market price for the first hedge leg and a second cross-market price for the second hedge leg;
calculating, by the computing device, an actual trading strategy price as a function of the first price, the first cross-market price, and the second cross-market price; and
if the calculated actual trading strategy price is equal to or better than the target trading strategy price, communicating, by the computing device, a trade action update to the electronic exchange.

2. A method as defined in claim 1, wherein the trade action update causes the first and second hedge legs to cross-the-market.

3. A method as defined in claim 2, wherein causing the first and second hedge legs to cross-the-market comprises allowing the first and second hedge legs to be filled at worse prices than target leg prices of the first and second hedge legs.

4. A method as defined in claim 1, wherein the trade action update includes an adjustment to at least one of the first and second hedge legs to increase a likelihood of the first and second hedge legs being completely filled.

5. A method as defined in claim 4, wherein the adjustment includes a change in an asking working price of the at least one of the first and second hedge legs.

6. A method as defined in claim 1, wherein the threshold amount comprises a number of price levels.

7. A method as defined in claim 1, wherein the threshold amount comprises an amount of money.

8. A tangible computer readable storage medium comprising instructions that, when executed, cause a machine to at least:
communicate a multi-legged trading strategy to an electronic exchange for execution, wherein the multi-legged trading strategy includes a target trading strategy price and at least three legs, the at least three legs including a quoting leg having a first target leg price, a first hedge leg, and a second hedge leg;
in response to the quoting leg being filled at a first price that is better than the target leg price by a threshold amount:
calculate a first cross-market price for the first hedge leg and a second cross-market price for the second hedge leg;
calculate an actual trading strategy price as a function of the first price, the first cross-market price, and the second cross-market price; and
communicate, if the calculated actual trading strategy price is equal to or better than the target trading strategy price, a trade action update to the electronic exchange.

9. A tangible computer readable storage medium as defined in claim 8, wherein the trade action update is to cause the first and second hedge legs to cross-the-market.

10. A tangible computer readable storage medium as defined in claim 9, wherein causing the first and second hedge legs to cross-the-market comprises allowing the first and second hedge legs to be filled at worse prices than target leg prices of the first and second hedge legs.

11. A tangible computer readable storage medium as defined in claim 8, wherein the trade action update includes an adjustment to at least one of the first and second hedge legs to increase a likelihood of the first and second hedge legs being completely filled.

12. A tangible computer readable storage medium as defined in claim 11, wherein the adjustment includes a change in a working asking price of the at least one of the first and second hedge legs.

13. A tangible computer readable storage medium as defined in claim 8, wherein the threshold amount comprises a number of price levels.

14. A tangible computer readable storage medium as defined in claim 8, wherein the threshold amount comprises an amount of money.

15. An apparatus, comprising:
an interface to communicate a multi-legged trading strategy to an electronic exchange for execution, wherein the multi-legged trading strategy includes a target trading strategy price and at least three legs, the at least three legs including a quoting leg having a target leg price, a first hedge leg, and a second hedge leg;
a hedge order management module to, in response to the quoting leg being filled at a first price that is better than the target leg price by a threshold amount:
calculate a first cross-market price for the first hedge leg and a second cross-market price for the second hedge leg;
calculate an actual trading strategy price as a function of the first price, the first cross-market price, and the second cross-market price; and
communicate, if the calculated actual trading strategy price is equal to or better than the target trading strategy price, a trade action update to the electronic exchange.

16. An apparatus as defined in claim 15, wherein the trade action update is to cause the first and second hedge legs to cross-the-market.

17. An apparatus as defined in claim 16, wherein causing the first and second hedge legs to cross-the-market comprises allowing the first and second hedge legs to be filled at worse prices than target leg prices of the first and second hedge legs.

18. An apparatus as defined in claim 15, wherein the trade action update includes an adjustment to at least one of the first and second hedge legs to increase a likelihood of the first and second hedge legs being completely filled.

19. An apparatus as defined in claim 18, wherein the adjustment includes a change in a working asking price of the at least one of the first and second hedge legs.

20. An apparatus as defined in claim 15, wherein the threshold amount comprises a number of price levels.

21. An apparatus as defined in claim 15, wherein the threshold amount comprises an amount of money.
